(19) United States
(12) Patent Application Publication
(10) Pub. No.: US 2005/0279086 A1
(43) Pub. Date: Dec. 22, 2005

(54) System for storing, delivering and recovering energy

(75) Inventor: Frank Hoos, AH Mijnsheerenland (NL)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SEATOOLS B.V., Numansdorp (NL)

(21) Appl. No.: 11/189,633

(22) Filed: Jul. 26, 2005

(30) Foreign Application Priority Data
Jan. 31, 2003 (NL) 1022536

(51) Int. Cl. F16D 31/02

(52) U.S. Cl. 60/413

(57) ABSTRACT

A system is described for storing, delivering and recovering energy, provided with a cylinder-piston assembly for absorbing a mass-induced load, which assembly is in fluid connection with a pressure source. The effective surface area of the piston of the cylinder-piston assembly is variable. The cylinder-piston assembly consists of, for instance, a number of cylinders connected in parallel, which can be selectively powered by the pressure source.

### BACKGROUND

1. Technical Field

A system for storing, delivering and recovering energy is disclosed which comprises a cylinder-piston assembly for absorbing a mass-induced load, which is in fluid connection with a pressure source.

2. Description of the Related Art

Such a system is used, inter alia, in a swell compensation system for compensating swell-induced motion of a mass suspended from a hoisting cable on ships or other floating installations.

Known systems can be divided into a number of different types. Hereinafter a short summary of the types and their specific problems is given.

In a passive system, the cylinder-piston assembly is directly connected to a pressure vessel (which contains a compressible gas). the passive system substantially behaves as a mass spring system, in which the gas volume and the gas pressure change under the influence of the mass-induced load. The drawbacks of such a system are the occurrence of resonance amplification effects, the presence of a substantial residual motion and the requirement of a large-volume pressure vessel. In addition, the system is only suitable for use with non-varying masses.

Although an active system (in which the cylinder-piston assembly can be actively controlled, inter alia, by placing a control mechanism between the pressure vessel and the cylinder-piston assembly) allows the use of a smaller pressure vessel volume and a slightly varying mass, such a system, inter alia, has this drawback that its energy consumption is very high, so that it is only suitable for small masses.

Characteristics of a combined passive/active system include: the gas volume in the pressure vessel can be adapted to the mass; the residual motion is small; the gas volume in the pressure vessel is smaller than in the case of a passive system; it is only suitable for non-varying masses.

Finally, systems provided with a so-called secondary control mechanism (usually on winches) may be mentioned, by means of which the stroke volume and thus the torque of a hydraulic driving motor can be controlled. Since the moment of inertia of such hydraulic driving motors is very low, the torque is very quickly converted into speed in the case of a varying load, so that the pressure vessel, which contains a great deal of energy, can cause the number of revolutions of the motor to run up inadmissibly high within a very short time. In principle such a system is unstable, therefore, and needs to be controlled by means of complex and dynamic measuring and control systems. For safety reasons, twin sensors must be used, which, in combination with the use of costly hydraulic components, processors and electronics, makes the system very costly. Furthermore, the energy losses that occur in such a system are very high, and the system can only be used with masses of a limited magnitude.

### SUMMARY OF THE DISCLOSURE

In view of the foregoing, an improved system is disclosed which combines the advantages of the known systems without having the drawbacks of the systems. In particular, a disclosed system preferably has the following characteristics: it is suitable for use with a large range of masses; it is capable of dynamically changing over from one mass to another; the volume of the pressure vessel is small; the energy consumption of the system is low and following precision (i.e. the degree of swell compensation) is high; the weight of the system is minimal; and the system is reliable and inexpensive.

Accordingly, a disclosed system is provided for storing, delivering and recovering energy, provided with a cylinder-piston assembly for absorbing a mass-induced load, which assembly is in fluid connection with a pressure source, the system being characterized in that the effective surface area of the piston of the cylinder-piston assembly is variable.

Since the effective piston area of the cylinder-piston assembly is variable, an equilibrium between the mass and the (gas) pressure of the pressure source (pressure vessel) can be achieved at all times. As a consequence, the gas pressure may vary very strongly (without the risk of resonance, for example), so that a greatly reduced volume of the pressure vessel will suffice. By selecting a suitable piston area at any moment, the desired force for a desired acceleration or deceleration of the piston of the cylinder-piston assembly, and thus of the mass, can be realized for any situation (within the system boundaries for any pressure vessel pressure). On the one hand the required energy is obtained from the pressure vessel, but on the other hand energy is returned to (stored in) the pressure vessel upon movement in reverse direction. Since practically no additional components are present between the pressure vessel and the cylinder-piston assembly, the system losses are very low and the efficiency is high, therefore.

In practice, the variation of the effective piston area of the cylinder-piston assembly will hardly take place in an infinitely variable manner, if at all (this would be technically unfeasible or, at the very least, be highly complicated). According to an advantageous embodiment, therefore, the cylinder-piston assembly consists of a number of cylinders connected in parallel, which can be selectively powered by the pressure source.

In this way a variation of the effective piston area can be realized by activating a suitable cylinder or cylinders.

Within this framework it is furthermore preferable to arrange the cylinders in groups of cylinders consisting of one cylinder or a number of cylinders to be simultaneously powered each time, wherein the total surface area of the pistons belonging to the same group of cylinders is halved or doubled each time, as the case may be, between successive groups of cylinders.

In this way, a binary solution for varying the piston area is provided, as it were. The number of effective piston areas to be realized is 2n-1 in that case, wherein n is the number of groups of cylinders. The precision of the variation (in other words, the adjusting precision or resolution of the system) is in principle determined by the minimum step size, i.e. the piston area of the group of cylinders having the smallest total piston area.

In order not to generate any asymmetrical forces within the cylinder-piston assembly (which leads to increased friction and wear and a higher energy consumption) in a situation in which the groups of cylinders are used, an advantageous embodiment is proposed wherein the cylinder-piston assembly has a central axis and wherein the cylinders of a group of cylinders are arranged in such a manner that the force produced by a group of cylinders extends through the central axis.

Within this framework, the pressure of at least the group of cylinders having the smallest total piston area can be controlled. As a result, a disclosed system is obtained in which the effective piston area of the cylinder-piston assembly is fully infinitely variable.

There are various possible ways of realizing the aforesaid groups of cylinders. An example of this is an embodiment of the system in which the cylinder-piston assembly is built up as follows:
a central first cylinder having a piston area 8B;
six second cylinders arranged around the central cylinder, each second cylinder likewise having a piston area 8B;
six third cylinders having a piston area B, which are arranged around the second cylinders in staggered and evenly spaced relationship,
wherein
four second cylinders, which are arranged in pairs positioned diametrically opposite each other, together form a first group of cylinders;
the two remaining second cylinders, which are likewise positioned diametrically opposite each other, together form a second group of cylinders;
the central first cylinder forms a third group of cylinders;
four evenly spaced third cylinders together form a fourth group of cylinders; and
the two remaining, likewise evenly spaced third cylinders together form a fifth group of cylinders.

The five groups of cylinders of this embodiment define five successive steps of the total piston area, wherein the total piston area is halved with each step. This makes it possible in practice to realize a sufficiently precise system comprising 31 (55−1) in different effective piston areas. Furthermore, the selected arrangement of the individual cylinders leads to a symmetrical force being exerted (along the central axis of the cylinder-piston assembly).

In this embodiment, the cylinder-piston assembly is made up of seven cylinders having a first piston area and six cylinders having a second piston area amounting to one eighth of the first piston area. The total number of cylinders is 13.

In an especially preferred embodiment of the system, the cylinder-piston assembly is built up as follows:
a central first double-acting cylinder having piston areas C and D; and
six second double-acting cylinders arranged around the central cylinder, each second cylinder likewise having piston areas C and D;
wherein
four second cylinders, which are arranged in pairs positioned diametrically opposite each other, together form a first group of cylinders with their one piston area C;
the two remaining second cylinders, which are likewise positioned diametrically opposite each other, together form a second group of cylinders with their one piston area C;
the central first cylinder forms a third group of cylinders with its one piston area C;
the four second cylinders arranged in pairs positioned diametrically opposite each other together form a fourth group of cylinders with their other piston area D;

the two remaining second cylinders, which are likewise positioned diametrically opposite each other, together form a fifth group of cylinders with their other piston area D; and
the central first cylinder forms a sixth group of cylinders with its other piston area D.

In this embodiment only seven cylinders are used, which, in addition, are all of the same type. Since the cylinders are double-acting type cylinders comprising two piston areas, it is possible, even with this minimum number of cylinders, to obtain a system which makes it possible, because six groups of cylinders are used, to set a large number of effective piston areas (viz. 2⁶−1=63), which results in a highly precise, high-resolution system.

Said system may again have the aforesaid binary characteristic, due to a suitable selection of the two different piston areas of the double-acting cylinders. Numerous variants are possible, of course.

In order to make it possible to vary the effective piston area, the system is preferably provided with control means for selectively connecting the cylinders to the pressure source. the control means may include sensors, which measure the mass-induced load, the pressure in the pressure vessel and the motion of the mass and/or the piston(s) of the cylinder-piston assembly, for example. Such sensors may be connected to a processing unit, which drives the control means via drive means. Such arrangements are known in the field of measuring and control engineering, and consequently they need not be explained in more detail herein.

The disclosed system may be used in a swell compensation system, and to a cylinder-piston assembly as used in a system according to the invention. Furthermore it may be noted within this framework that the invention may also be used with cylinder-piston assemblies used for purposes other than in swell compensation systems, for example more generally in lifting and hoisting arrangements.

### BRIEF DESCRIPTION OF THE DRAWINGS

The disclosed systems will be explained in more detail with reference to the accompanying drawings, wherein:

FIG. 1 illustrates the principles of a swell compensation system based on a prior art passive system;

FIG. 2 schematically illustrates a disclosed swell compensation system according to the invention;

FIGS. 3 and 4 illustrate various cylinder configuration is for disclosed swell compensation systems; and

FIG. 5 illustrates an alternative cylinder configuration substantially corresponding to FIG. 4.

### DETAILED DESCRIPTION OF THE PRESENTLY PREFERRED EMBODIMENTS

FIG. 1 schematically illustrates a ship 1 which carries a load (mass) 2a. the load 2 may be raised and lowered, in a manner that is known per se (not shown), by means of a hoisting installation. The load 2 may be part of an installation which is used for carrying out underwater operations, e.g. on the bottom of the sea. In order to compensate for any swell-induced vertical movements of the ship 1, the load is suspended from a cable 3, which is passed over a pulley 4 and which is attached to the ship 1 (with the possible interposition of a hoisting installation or the like as mentioned before). The pulley is mounted on the piston rod 5 of a piston 6 of a cylinder-piston assembly 7. The cylinder chamber 8 of the cylinder-piston assembly 7 is in fluid connection with a pressure vessel 10 via a line 9. Present within the pressure vessel is a piston or membrane 11, which seals a gas chamber 12.

During vertical movement of the ship 1 in upward direction, the load 2 exerts a downward force on the pulley 4 via the cable 3, which pulley transmits the force to the piston 6 via the piston rod 5. The piston 6 is moved and the hydraulic medium that is present in the cylinder chamber 8 and the line 9 is displaced, as a result of which the piston or membrane 11 in the pressure vessel 10 are moved, so that the gas pressure in the gas chamber 12 will increase. The reverse process takes place during vertical movement of the ship in an opposite, downward direction. Upon compression of the gas in the gas chamber 12 of the pressure vessel 10, energy is stored in the pressure vessel, which energy is to a substantial extent released again (not counting any losses) upon movement in reverse direction.

In the known swell compensation system that is shown in FIG. 1, the surface area of the piston 6 is constant. The drawbacks of this configuration have already been extensively discussed in the foregoing.

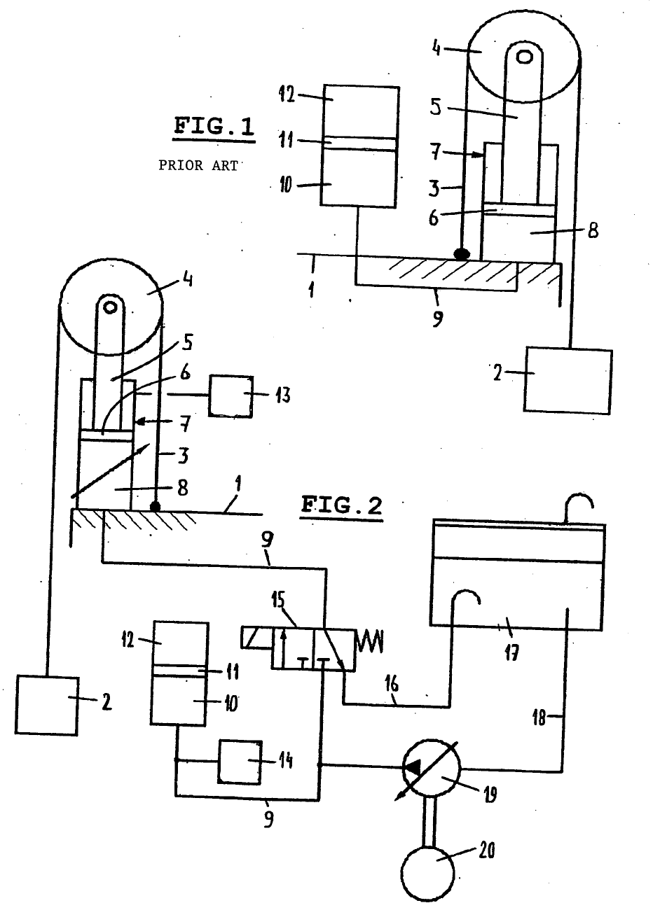

In FIG. 2 illustrates a disclosed swell compensation system. The basic principle of this system corresponds to the basic principle of the known system as shown in FIG. 1: a load 2 is connected to a ship 1 via a cable 3 that is passed over a pulley 4 which is (directly or indirectly) connected to a ship 1. The pulley 4 is mounted on a piston rod 5 of a cylinder-piston assembly 7.

In the swell compensation system of FIG. 2, the surface area of the piston 6 is no longer constant, but variable. This makes it possible to select the most suitable piston area for every situation that may occur, as already explained at some length in the foregoing. The adjustment/variation of the surface area of the piston 6 of the cylinder-piston assembly 7 is realized in a manner yet to be described as a result of the cylinder-piston assembly 7 consisting of a number of cylinders connected in parallel, which can be selectively powered by the pressure vessel 10. The variation in the surface area of the piston 6 will preferably take place automatically in response to measuring signals from the sensors 13 and 14 for measuring, inter alia, the pressure in the cylinder-piston assembly 7, the movement of the piston 6 and the pressure in the hydraulic lines 9 that connect the cylinder chambers 8 of the individual cylinders to the pressure vessel 10. The sensors 13, 14 are connected, in a manner that is not shown, to processing and control means for varying the piston area on the basis of received sensor signals.

In the illustrated embodiment of FIG. 2, the varying of the piston area takes place by means of control valves 15 mounted in the lines 9, one for every cylinder or (in the embodiment yet to be described) group of cylinders, which control valves are actuated by the processing and control means, which thus activate/deactivate the respective individual cylinders of the cylinder-piston assembly 7. In connection with undesirable dissipation, the valves are either in their open position or in their closed position. A very short time is required for movement of the vales from the open position to the closed position, or vice versa.

The hydraulic circuit (lines 9) is also connected to a storage vessel 17 for the hydraulic medium, in this case a so-called low-pressure battery, via the control valves 15 and a discharge line 16. In this way excess hydraulic medium can be carried to the storage vessel 17. A supply line 18, in which a pump 19 driven by a motor 20 is mounted, connects the storage vessel 17 to the hydraulic circuit (lines 9). In this way any losses of hydraulic medium can be replenished.

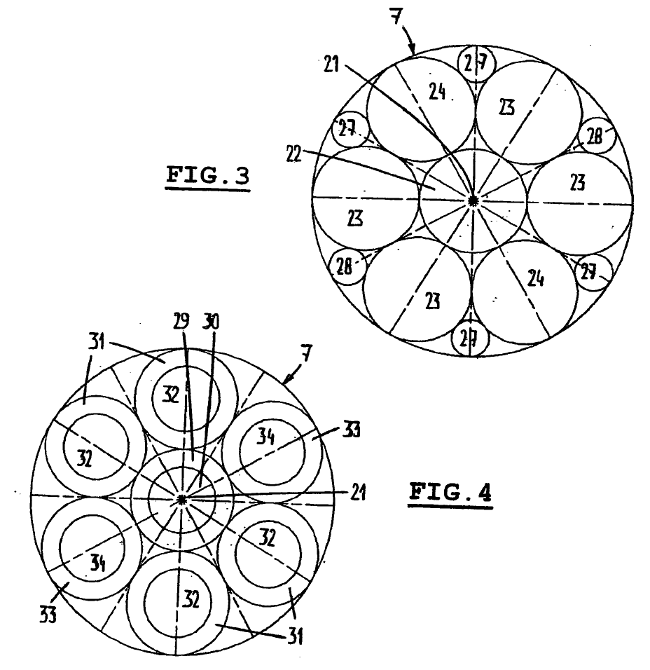

In order to make it possible to vary the effective piston area of the cylinder-piston assembly 7 in the swell compensation system according to the invention, for example as shown in FIG. 2, the cylinder-piston assembly consists of a number of cylinders connected in parallel, as already the before, which can be selectively powered by the pressure vessel 10. As will be explained hereinafter by means of the embodiments shown in FIGS. 3-5, the cylinders are arranged in groups of cylinders consisting of one cylinder or a number of cylinders to be powered simultaneously. In the case of successive groups of cylinders, the total surface area of the pistons belonging to the same group of cylinders amounts to twice the piston area or half the piston area of a preceding group of cylinders with each step.

The foregoing will be explained with reference to FIGS. 3 and 4, which are schematic cross-sectional views of cylinder-piston assemblies built up of a number of individual cylinders.

Preliminarily, it is noted in this connection that each cylinder-piston assembly that is shown in the figures has a central axis 21 and that the cylinders of a group of cylinders are arranged in such a manner that the force exerted by a group of cylinders will extend through the central axis 21. As a result, the amount of a wear and friction is minimized.

Referring to FIG. 3, the cylinder-piston assembly is built up as follows:
the central first cylinder 22 having a piston area 8B;
the six second cylinders 23 and 24 arranged around the central cylinder 22, each second cylinder likewise having a piston area 8B;
six third cylinders 27 and 28 having a piston area B, which are arranged around the second cylinders 23 and 24 in staggered and evenly spaced relationship.

The cylinders 22-24 and 27, 28 are grouped as follows:
the four second cylinders 23, which are arranged in pairs positioned diametrically opposite each other, together form a first group of cylinders having a total piston area 32B;
the two remaining second cylinders 24, which are likewise positioned diametrically opposite each other, together form a second group of cylinders having a total piston area 16B;
the central first cylinder 22 again forms a third group of cylinders having a total piston area 8B;
four evenly spaced third cylinders together form a fourth group of cylinders having a total piston area 4B; and
the two remaining, likewise evenly spaced third cylinders 28, together form a fifth group of cylinders having a total piston area 2B.

The successive groups of cylinders from the first group to the fifth group have total piston areas that are halved each time, so that a binary system in total comprising 31 steps (25−1), is obtained, as it were. As a result, the effective piston area of the cylinder-piston assembly 7 can be varied by suitably activating the groups of cylinders (e.g. by means of the control valves 15, see FIG. 2) at a high resolution (the step size corresponds to the smallest total piston area 2B). This system comprises a total of 13 cylinders having two different piston areas (diameters).

Finally, reference is made to FIG. 4. In this embodiment, the swell compensation system comprises a cylinder-piston assembly which is built up as follows:
a central first double-acting cylinder having piston areas C and D; and
six second double-acting cylinders arranged around the central cylinder, each second cylinder likewise having piston areas C and D.

The cylinders are arranged in groups in the following manner:
the first parts 31 of four second cylinders 31, 32, which are arranged in pairs positioned diametrically opposite each other, together form a first group of cylinders having a total piston area 4C with their respective piston areas C;
the first parts 33 of the two remaining second cylinders 33, 34, which are likewise positioned diametrically opposite each other, together form a second group of cylinders having a total piston area 2C with their respective piston areas C;
the first part 29 of the central first cylinder 29, 30 forms a third group of cylinders having a total piston area C with its piston area C;
the second parts 32 of four second cylinders 31, 32, which are arranged in pairs positioned diametrically opposite each other, together form a fourth group of cylinders having a total piston area 4D with their respective piston areas D;
the second parts 34 of the two remaining second cylinders 33, 34, which are likewise positioned diametrically opposite each other, together form a fifth group of cylinders having a total piston area 2D with their respective piston areas D; and
the second part 30 of the central first cylinder 29, 30 forms a sixth group of cylinders having a total piston area D with its piston area D.

A suitable selection of the piston areas C and D and a suitable control of this system comprising double-acting cylinders will result in a binary system comprising. 26−1=63 steps. As a result, a high-resolution (about 1.5%) system will be obtained, which allows a precise adaptation of the effective piston area to the prevailing conditions.

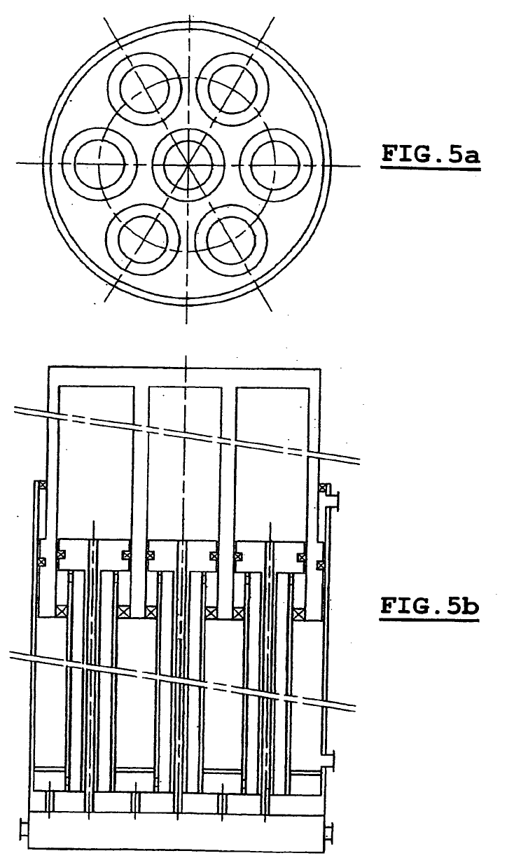

Furthermore, the individual cylinders may be grouped into one cylinder, which can be activated as a whole. An example of such a configuration is schematically shown in FIGS. 5a and 5b. FIG. 5a illustrates a cylinder configuration corresponding to FIG. 4, and FIG. 5b is a longitudinal sectional view thereof. In the figure, the grouping of cylinders into one cylinder is clearly shown.

One preferred embodiment of the swell compensation system comprises an intermediate pressure vessel. The hydraulic medium, generally oil, that is present in the system is slightly compressible, so that energy is stored in the oil present in the cylinders upon pressurization of the cylinders. the energy is lost when the pressure is released from the cylinders again: the “oil spring” relaxes and the energy that is released is transmitted to the storage vessel. The intermediate pressure vessel collects part of the energy, so that it can be utilized at a later stage.

The operation is as follows: when the pressure is released from the cylinders, the cylinders are not directly connected to the storage vessel, but they are first (briefly) connected to the intermediate pressure vessel (e.g. by providing the aforesaid control valves 15 with a fourth position, which is capable of connecting the lines 9 to the intermediate pressure vessel). The oil spring relaxes, whilst the cylinder pressure decreases to the intermediate pressure level, and the energy that is released from the spring is stored in the intermediate pressure vessel. When the intermediate pressure amounts to, for example, half the difference between the system pressure and the pressure in the storage vessel (e.g. an atmospheric pressure), about half the energy that would otherwise have been lost may can be stored in the intermediate pressure vessel.

The energy in the intermediate pressure vessel is used again when one or more cylinders go through the reverse process: a cylinder is not immediately turned to full pressure in that case, but it is first temporarily connected to the intermediate pressure vessel, so that the energy from the vessel is utilized for tensioning the oil spring to half its full tension again.

The principle of the intermediate pressure vessel may be extended with more vessels or reservoirs, it would for example be possible to add a reservoir at 0.25 and 0.75 of the system pressure. The more reservoirs are provided, the more energy will be recovered.

The disclosed system is not limited to the embodiments as described above, and can be varied in many ways within the scope of the appended claims.

1. A system for storing, delivering and recovering energy, the system comprising:
a cylinder-piston assembly for absorbing a mass-induced load, the cylinder-piston assembly comprising a piston having a variable surface area,
the cylinder-piston assembly being in fluid communication with a pressure source.

2. A system according to claim 1, wherein the cylinder-piston assembly comprises a plurality of cylinders connected in parallel, wherein the cylinders can be selectively powered by the pressure source.

3. A system according to claim 2, wherein the cylinders are arranged in groups of cylinders consisting of one or more cylinders simultaneously powered.

4. A system according to claim 3, wherein the cylinder-piston assembly has a central axis and wherein the cylinders of a group of cylinders are arranged in such a manner that the force produced by a group of cylinders extends along the central axis.

5. A system according to claim 3, wherein a pressure of at least one group of cylinders can be controlled.

6. A system according to claim 4, wherein a pressure of at least one group of cylinders can be controlled.

7. A system according to claim 3, wherein the cylinder-piston assembly further comprises:
a central first cylinder having a first piston area;
six second cylinders arranged around the central cylinder, each second cylinder likewise having a second piston area;
six third cylinders arranged around the second cylinders and evenly spaced apart from each other, each third cylinder having a third piston area,
wherein four of the second cylinders, which are arranged in pairs positioned diametrically opposite each other, together form a first group of cylinders;
wherein the two remaining second cylinders, which are likewise positioned diametrically opposite each other, together form a second group of cylinders;
the central first cylinder forms a third group;
four evenly spaced third cylinders together form a fourth group of cylinders; and
the two remaining, likewise evenly spaced third cylinders together form a fifth group of cylinders.

8. A system according to claim 4, wherein the cylinder-piston assembly further comprises:
a central first cylinder having a first piston area;
six second cylinders arranged around the central cylinder, each second cylinder likewise having a second piston area;
six third cylinders arranged around the second cylinders and evenly spaced apart from each other, each third cylinder having a third piston area,
wherein four of the second cylinders, which are arranged in pairs positioned diametrically opposite each other, together form a first group of cylinders;
wherein the two remaining second cylinders, which are likewise positioned diametrically opposite each other, together form a second group of cylinders;
the central first cylinder forms a third group;
four evenly spaced third cylinders together form a fourth group of cylinders; and
the two remaining, likewise evenly spaced third cylinders together form a fifth group of cylinders.

9. A system according to claim 5, wherein the cylinder-piston assembly further comprises:
a central first cylinder having a first piston area;
six second cylinders arranged around the central cylinder, each second cylinder likewise having a second piston area;
six third cylinders arranged around the second cylinders and evenly spaced apart from each other, each third cylinder having a third piston area,
wherein four of the second cylinders, which are arranged in pairs positioned diametrically opposite each other, together form a first group of cylinders;
wherein the two remaining second cylinders, which are likewise positioned diametrically opposite each other, together form a second group of cylinders;
the central first cylinder forms a third group;
four evenly spaced third cylinders together form a fourth group of cylinders; and
the two remaining, likewise evenly spaced third cylinders together form a fifth group of cylinders.

10. A system according to claim 6, wherein the cylinder-piston assembly further comprises:
a central first cylinder having a first piston area;
six second cylinders arranged around the central cylinder, each second cylinder likewise having a second piston area;
six third cylinders arranged around the second cylinders and evenly spaced apart from each other, each third cylinder having a third piston area,
wherein four of the second cylinders, which are arranged in pairs positioned diametrically opposite each other, together form a first group of cylinders;
wherein the two remaining second cylinders, which are likewise positioned diametrically opposite each other, together form a second group of cylinders;
the central first cylinder forms a third group;
four evenly spaced third cylinders together form a fourth group of cylinders; and
the two remaining, likewise evenly spaced third cylinders together form a fifth group of cylinders.

11. A system according to claim 3, wherein the cylinder-piston assembly further comprises:
a central first double-acting cylinder having first and second piston areas, the first piston area being twice as large as the second piston area;
six second double-acting cylinders arranged around the central cylinder, each second cylinder likewise also having first and second piston areas;
wherein four second cylinders are arranged in pairs positioned diametrically opposite each other and form a first group of cylinders each having a first piston area;
and two remaining second cylinders are positioned diametrically opposite each other to form a second group of cylinders each having a first piston area;
the central first cylinder forms a third group having its first piston area;
the four second cylinders arranged in pairs positioned diametrically opposite each other also form a fourth group of cylinders each having a second piston area;
the two remaining second cylinders positioned diametrically opposite each other also form a fifth group of cylinders each having a second piston area; and
the central first cylinder also forms a sixth group of cylinders with its second piston area.

12. A system according to claim 4, wherein the cylinder-piston assembly further comprises:
a central first double-acting cylinder having first and second piston areas, the first piston area being twice as large as the second piston area;
six second double-acting cylinders arranged around the central cylinder, each second cylinder likewise also having first and second piston areas;
wherein four second cylinders are arranged in pairs positioned diametrically opposite each other and form a first group of cylinders each having a first piston area;
and two remaining second cylinders are positioned diametrically opposite each other to form a second group of cylinders each having a first piston area;
the central first cylinder forms a third group having its first piston area;
the four second cylinders arranged in pairs positioned diametrically opposite each other also form a fourth group of cylinders each having a second piston area;
the two remaining second cylinders positioned diametrically opposite each other also form a fifth group of cylinders each having a second piston area; and
the central first cylinder also forms a sixth group of cylinders with its second piston area.

13. A system according to claim 5, wherein the cylinder-piston assembly further comprises:
a central first double-acting cylinder having first and second piston areas, the first piston area being twice as large as the second piston area;
six second double-acting cylinders arranged around the central cylinder, each second cylinder likewise also having first and second piston areas;
wherein four second cylinders are arranged in pairs positioned diametrically opposite each other and form a first group of cylinders each having a first piston area;
and two remaining second cylinders are positioned diametrically opposite each other to form a second group of cylinders each having a first piston area;
the central first cylinder forms a third group having its first piston area;
the four second cylinders arranged in pairs positioned diametrically opposite each other also form a fourth group of cylinders each having a second piston area;
the two remaining second cylinders positioned diametrically opposite each other also form a fifth group of cylinders each having a second piston area; and
the central first cylinder also forms a sixth group of cylinders with its second piston area.

14. A system according to claim 6, wherein the cylinder-piston assembly further comprises:
a central first double-acting cylinder having first and second piston areas, the first piston area being twice as large as the second piston area;
six second double-acting cylinders arranged around the central cylinder, each second cylinder likewise also having first and second piston areas;
wherein four second cylinders are arranged in pairs positioned diametrically opposite each other and form a first group of cylinders each having a first piston area;
and two remaining second cylinders are positioned diametrically opposite each other to form a second group of cylinders each having a first piston area;
the central first cylinder forms a third group having its first piston area;
the four second cylinders arranged in pairs positioned diametrically opposite each other also form a fourth group of cylinders each having a second piston area;
the two remaining second cylinders positioned diametrically opposite each other also form a fifth group of cylinders each having a second piston area; and
the central first cylinder also forms a sixth group of cylinders with its second piston area.

15. A system according to claim 2 further comprising a control means for selectively connecting the cylinders to the pressure source.

16. A system according to claim 1, wherein the pressure source is a pressure vessel.

17. A system according to claim 1 wherein the system comprises part of a swell compensation system.

18. A system according to claim 1, further comprising a low-pressure reservoir and an intermediate pressure reservoir, wherein the cylinders can be connected to either one of the reservoirs.

19. A swell compensation system comprising:
a cylinder-piston assembly for absorbing a mass-induced load, the cylinder-piston assembly comprising a plurality of cylinders and pistons providing a variable total piston surface area, the cylinder-piston assembly being in fluid communication with a pressure source;
the plurality of cylinders being connected in parallel, wherein the cylinders can be selectively powered by the pressure source;
the plurality of cylinders being arranged in groups of cylinders consisting of one or more cylinders simultaneously powered and wherein a pressure of each group can be controlled;
the cylinder-piston assembly having a central axis and wherein the cylinders of a group of cylinders are arranged in such a manner that the force produced by a group of cylinders extends along the central axis;
the plurality of cylinders and groups of cylinders comprising
a central first cylinder having a first piston area;
six second cylinders arranged around the central cylinder, each second cylinder likewise having a second piston area;
six third cylinders arranged around the second cylinders and evenly spaced apart from each other, each third cylinder having a third piston area,
wherein four of the second cylinders, which are arranged in pairs positioned diametrically opposite each other, together form a first group of cylinders;
wherein the two remaining second cylinders, which are likewise positioned diametrically opposite each other, together form a second group of cylinders;
the central first cylinder forms a third group;
four evenly spaced third cylinders together form a fourth group of cylinders; and
the two remaining, likewise evenly spaced third cylinders together form a fifth group of cylinders.

20. A swell compensation system comprising:
a cylinder-piston assembly for absorbing a mass-induced load, the cylinder-piston assembly comprising a plurality of cylinders and pistons providing a variable total piston surface area, the cylinder-piston assembly being in fluid communication with a pressure source;
the plurality of cylinders being connected in parallel, wherein the cylinders can be selectively powered by the pressure source;
the plurality of cylinders being arranged in groups of cylinders consisting of one or more cylinders simultaneously powered and wherein a pressure of each group can be controlled;
the cylinder-piston assembly having a central axis and wherein the cylinders of a group of cylinders are arranged in such a manner that the force produced by a group of cylinders extends along the central axis;
the plurality of cylinders and groups of cylinders comprising
a central first double-acting cylinder having first and second piston areas, the first piston area being twice as large as the second piston area;
six second double-acting cylinders arranged around the central cylinder, each second cylinder likewise also having first and second piston areas;
wherein four second cylinders are arranged in pairs positioned diametrically opposite each other and form a first group of cylinders each having a first piston area;
and two remaining second cylinders are positioned diametrically opposite each other to form a second group of cylinders each having a first piston area;
the central first cylinder forms a third group having its first piston area;
the four second cylinders arranged in pairs positioned diametrically opposite each other also form a fourth group of cylinders each having a second piston area;
the two remaining second cylinders positioned diametrically opposite each other also form a fifth group of cylinders each having a second piston area; and
the central first cylinder also forms a sixth group of cylinders with its second piston area.
